(19) United States
(12) Patent Application Publication
(10) Pub. No.: US 2017/0312711 A1
(43) Pub. Date: Nov. 2, 2017

(54) COIL APPARATUS, SYSTEM, AND RELATED METHOD

(71) Applicant: FIG & CROW, LLC, Miami, FL (US)

(72) Inventor: Alicia Cuervo, Miami, FL (US)

(73) Assignee: FIG & CROW, LLC, Miami, FL (US)

(21) Appl. No.: 15/581,718

(22) Filed: Apr. 28, 2017

Related U.S. Application Data
(60) Provisional application No. 62/328,932, filed on Apr. 28, 2016.

(51) Int. Cl. B01F 13/00; A61J 9/00; B01F 3/12

(52) U.S. Cl. CPC B01F 13/0057; B01F 13/0022; A61J 9/00; B01F 3/12

(57) ABSTRACT

The invention disclosed herein is a novel coil apparatus, system, and related method, useful for the mixing and agitation of a powdered substance into a liquid. The coil has features and is configured such that the edges of the coil can reach the inside corners of the bottle or container to provide improved mixing and cleaning of the container. Embodiments of the coil also terminate in a figure or logo that provides a way to mark or brand the product. When combined with a bottle, the system provides a way to store, mix, and clean baby formula, as well as entertain an infant by creating a rattling sound within the bottle.

### CROSS-REFERENCE TO RELATED APPLICATIONS

This application for a United States Letters Patent is a non-provisional of, and claims the benefit of, U.S. Provisional Patent Application No. 62/328,932, filed on 28 Apr. 2016, currently pending, which is incorporated by reference as if fully incorporated herein.

### STATEMENT REGARDING FEDERALLY SPONSORED-RESEARCH OR DEVELOPMENT

None.

### FIELD OF THE INVENTION

The invention relates generally to the field of mechanical apparatuses, and more particularly, to a coil apparatus, coil-bottle system, and related method.

### BACKGROUND

The mixing of two substances in a container is a problem that has long been present in the art. Especially in the field of infant nutrition, the proper and sanitary mixing of powdered baby formula with clean water directly in a baby's bottle has presented many problems.

Infants require frequent feeding. Liquid formula, milk, and other pre-mixed liquids require refrigeration to prevent spoilage. The advent of powdered baby formula has allowed caregivers to be more mobile and feed their babies on the go. Caregivers soon discover that what is easy and convenient at home, is often difficult and cumbersome while traveling. Without ready access to dishwashers and sanitizers, preparing and cleaning the bottles proves to be difficult. Powders are difficult to transfer in to a bottle for on the go mixing. Powdered formula that is not properly mixed will dry and leave residue on the bottle interior, leading to unsanitary conditions. Furthermore, all of this has to be accomplished while trying to entertain a hungry infant.

Previous attempts available in the prior art have tried to solve these problems through the use of elaborate, multi-part devices. Some attempts disclose devices for storing powder in a bottle until just prior to consumption, with provisions for rapidly combining and mixing the liquid and the powder without opening the bottle. Some solutions attempt to address the problems in the prior art through new bottle designs or through devices that fit into a standard bottle.

Other prior attempts in the art disclose holding the formula powder in a cartridge inside a baby bottle with the water stored in the bottle below. Others disclose a reusable insert designed for standard baby bottles to keep the formula powder and water separate until a push rod forces a chamber seal into the water portion of the bottle. Activation in this case involves the unsanitary act of pushing on the nipple. Yet other attempted solutions teach a long-stemmed disk that is dislodged and falls into the liquid allowing the powder to mix with the water.

While other solutions in the art have attempted to provide a storage, mixing, or cleaning solution, they tend to fail in one or more respects. In addition to ease of use, caregivers are looking towards safety and cleanliness. Furthermore, caregivers of infants are always looking for a way to entertain.

It would, therefore, be desirable to have an apparatus for the mixing of powdered formula in a baby bottle that is clean, inexpensive, safe and entertaining. It would also be desirable to have a system comprising a mixer apparatus and a baby bottle as well as a related method for using said system.

While certain aspects of conventional technologies have been discussed to facilitate disclosure of the invention, Applicant in no way disclaims these technical aspects, and it is contemplated that the claimed invention may encompass one or more of the conventional technical aspects discussed herein.

In this specification where a document, act, or item of knowledge is referred to or discussed, this reference or discussion is not an admission that the document, act, or item of knowledge or any combination thereof was at the priority date, publicly available, known to the public, part of common general knowledge, or otherwise constitutes prior art under the applicable statutory provision; or is known to be relevant to an attempt to solve any problem with which this specification is concerned.

### SUMMARY

A preferred embodiment of the present invention is directed to a coil apparatus. The apparatus comprises a coil with a first end, a second end, and a body extending between the first end and the second end. The body of the coil apparatus spirals about a central axis in a predetermined geometric cross-sectional trajectory. The coil apparatus pitch and trajectory along the central axis is configured such that the maximum trajectory radius closest to the first end is larger than the trajectory radius closest to the second end. Furthermore, the coil apparatus pitch and trajectory is chosen such that the outer shape of the coil is of a predetermined shape, for example: a half-sphere, cone, cylinder, polygon or other geometric shape.

Another embodiment of the present invention discloses a coil-bottle system comprised of a coil apparatus, as described herein, and a bottle. The bottle in this system is configured to have an opening with a diameter smaller than the bottle interior. The coil apparatus in this system is configured such that the largest dimension of the apparatus is larger than the opening of the bottle but smaller than the bottle interior. In this way, the coil apparatus is deformable for insertion in to the bottle, yet is capable of returning to its default shape and, thus, is constrained by the bottle once inserted.

Yet another embodiment of the present invention discloses a method of use of the system described herein. The method is comprised of the steps of: providing a bottle with a sealable opening and an interior with a cross section larger than the opening cross section; providing a bottle seal; providing a coil apparatus configured to be larger than the bottle opening in its non-deformed state, but also smaller that the bottle interior; providing powdered formula; providing drinking water; deforming temporarily the coil apparatus; inserting the deformed coil apparatus into the bottle; releasing the coil apparatus so that it returns to its default shape; inserting the powdered formula into the bottle; inserting the drinking water in to the bottle; attaching the bottle seal onto the bottle; and shaking the bottle, whereby the coil-bottle system mixes the powdered formula.

A “bottle seal,” as disclosed herein, is any method of substantially covering the bottle opening so that the contents do not fall out of the bottle when the bottle is agitated. Examples of a bottle seal include, but are not limited to, screw on caps and screw on caps with integrated nipples.

“Powdered formula,” as disclosed herein, is any dry or semi-dry formulation that is combined with a liquid within the bottle, and is mixed with the liquid by the agitating action of the various embodiments of the coil apparatus within the bottle. Powdered formula may include, but is not limited to powdered baby formula, protein powder, and dry or semi-dry (concentrated) supplements to be consumed in liquid form by combination with a liquid.

Certain embodiments of the present invention may be used for, but are not limited to, the storing, mixing, and cleaning of baby formula. It is contemplated, however, that the use of certain embodiments of the present invention in other applications beyond the mixing of baby formula, is within the scope of the present invention. For example, the invention may be used for mixing other substances, use in applications other than on humans, or for other medical or industrial uses.

Embodiments of the present invention may include components manufactured from various materials based upon the contemplated use. For embodiments that are contemplated for human use, materials that are durable, non-toxic, non-reactive, and sanitary are contemplated to be within the scope of the present invention. By way of example and not limitation, materials may be stainless steel, spring steel, non-reactive alloys, or polycarbonates.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

### BRIEF DESCRIPTION OF THE DRAWINGS

These and other features, aspects, and advantages of the present invention will become better understood with regard to the following description, appended claims, and accompanying drawings where:

FIG. 1 is a front view of an embodiment of the invention showing a coil apparatus within a standard baby bottle;

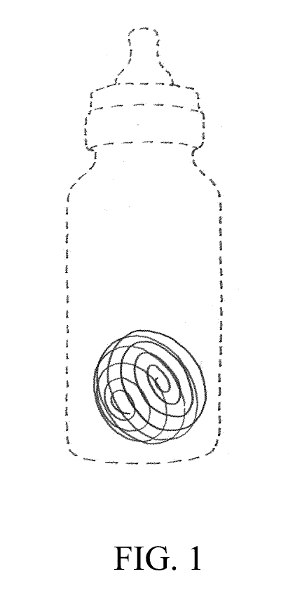

FIG. 2 is a composite view illustrating a coil apparatus being inserted into a standard baby bottle, according to an embodiment of the present invention;

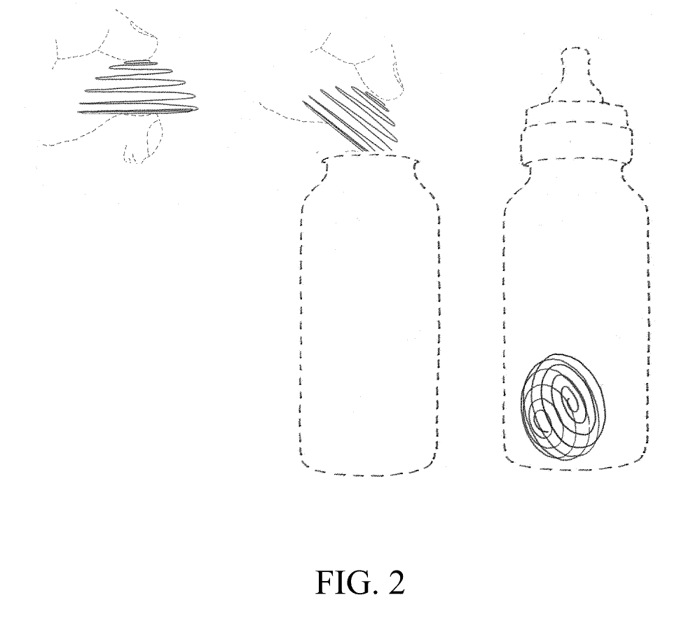

FIG. 3 is a composite view showing a coil apparatus in a pinched state and a not pinched state, according to an embodiment of the present invention;

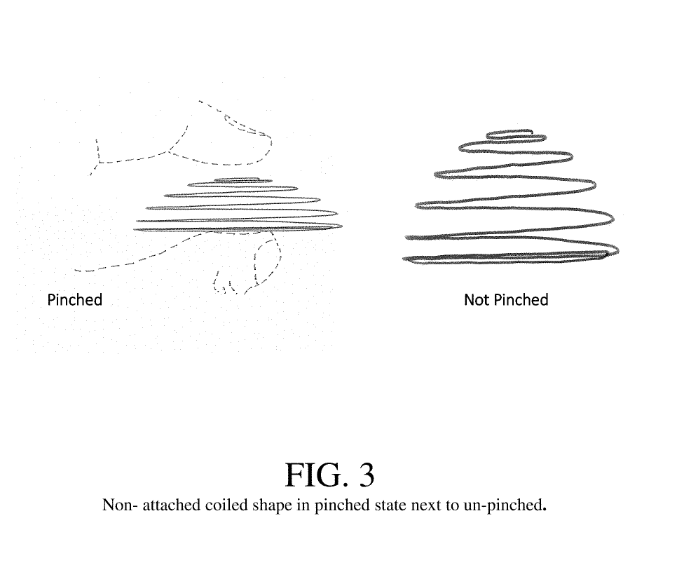

FIG. 4 is a composite view illustrating a coiled apparatus within a standard baby bottle being used to make rattle noise by shaking, according to an embodiment of the present invention;

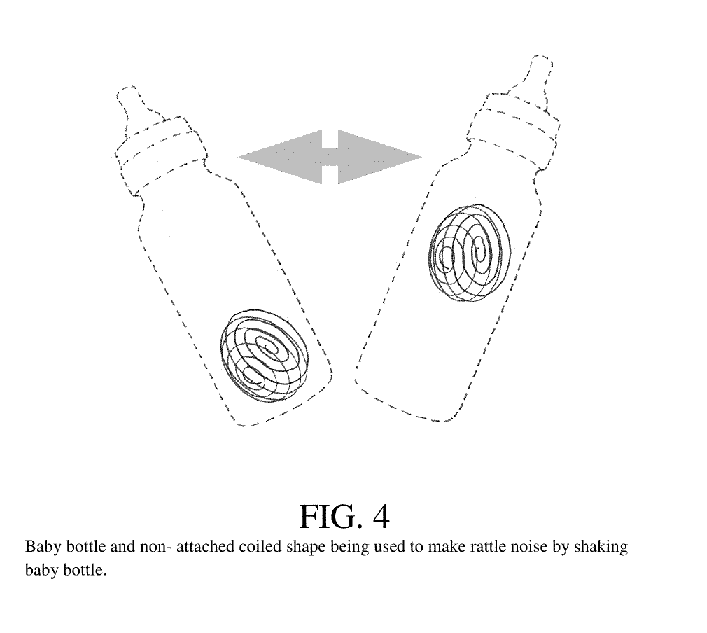

FIG. 5 shows a composite view illustrating use of the coil apparatus to mix soluble substances in a bottle, according to an embodiment of the present invention;

FIG. 6 shows a composite view illustrating use of the coil apparatus to clean a bottle, according to an embodiment of the present invention;

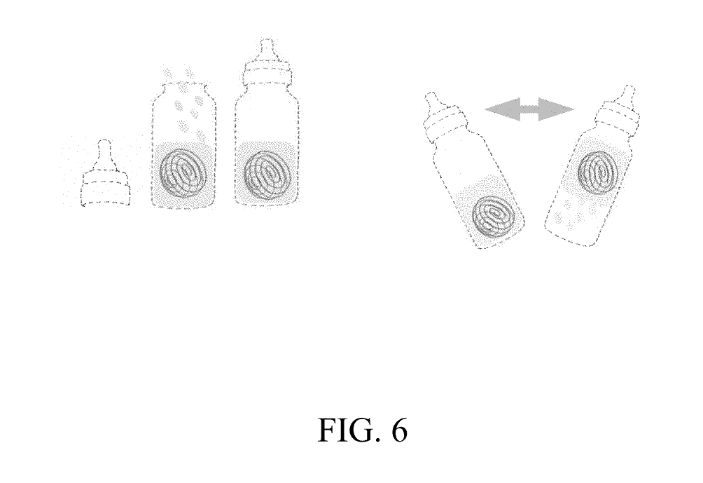

FIG. 7 shows a composite of FRONT, BOTTOM, and BOTTOM ISO views of the coil apparatus, according to an embodiment of the present invention;

FIG. 8 shows a composite of TOP, FRONT, BOTTOM, and BOTTOM ISO views of the coil apparatus, according to an embodiment of the present invention;

FIG. 9 shows a composite view illustrating a comparison between the prior art and an embodiment of the present invention; and

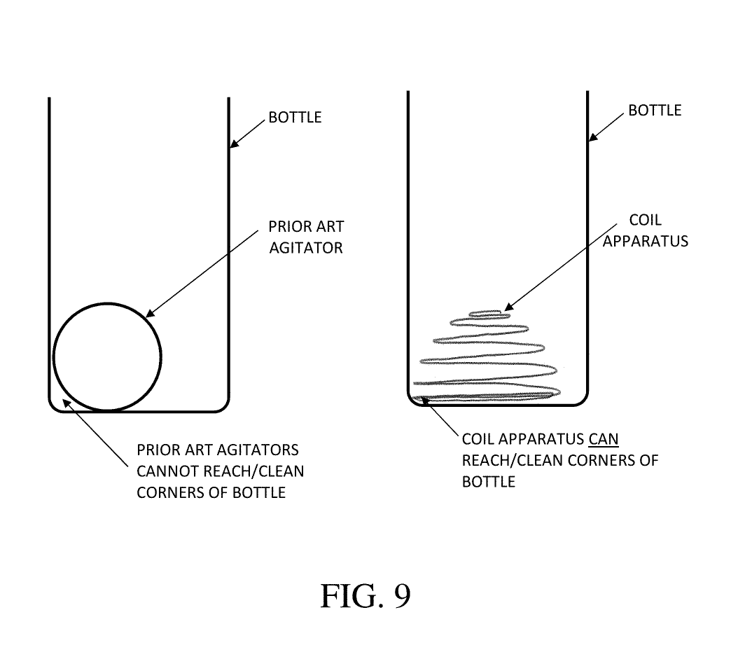

FIG. 10 is a flow chart showing the steps of a method of using the system according to an embodiment of the invention.

### DESCRIPTION

In the Summary above, in the Description below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, structures, steps, etc. are optionally present. For example, an article “comprising” (or “which comprises”) components A, B, and C can consist of (i.e., contain only) components A, B, and C, or can contain not only components A, B, and C, but also one or more other components or structures.

The term “at least” followed by a number is used herein to denote the start of a range beginning with that number (which may be a range having an upper limit or no upper limit, depending on the variable being defined). For example, “at least 1” means 1 more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40% means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

The term “mechanical features” is used herein to mean features of a component, mechanical or geometric, which have a functional purpose of attaching or linking that component to one or more other components with compatible or corresponding mechanical features. An example of a mechanical feature is a slot in a component, where said slot is designed to accept a tab from another component and the union of the slot and tab from the two components effectively links, attaches, fixes, and/or locks the components together. The term “mechanical features” refers to, but is not limited to: hooks, hook and loop fasteners, slot and tabs, all male and female fasteners, screws, bolts, nuts, holes that have been tapped, latches, pins, etc.

While the specification will conclude with claims defining the features of embodiments of the invention that are regarded as novel, it is believed that the invention will be better understood from a consideration of the following description in conjunction with the figures, in which like reference numerals are carried forward.

Coil Apparatus 100

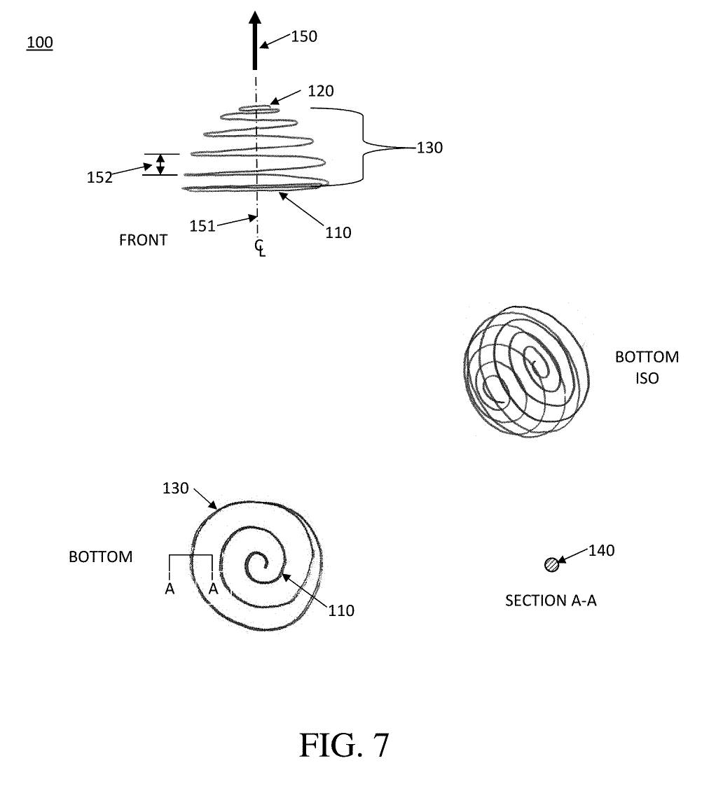

Referring to the figures in general, and to FIG. 7 in particular, a preferred embodiment of the present invention in the form of a coil apparatus 100 is disclosed here. In the preferred embodiment, the apparatus comprises the following structures: a first end 110, a second end 120, and a body 130.

In the preferred embodiment of the invention in the form of a coil apparatus 100, the body 130 extends between the first end 110 and the second end 120. The cross-section 140 of the body 130 is substantially consistent between the first end 110 and the second end 120. While the preferred embodiment shown in the figures, and in FIG. 7 in particular, discloses a cross-section 140 that is circular, it is contemplated to be within the scope of the invention that the cross section 140 may be of any two-dimensional shape. By way of example, and not limitation, cross section 140 may be a circle, oval, square, rectangle, or star.

Body 130 follows a pre-determined trajectory 150, revolving about a central axis 151, and at a pre-determined pitch 152. The trajectory 150 is chosen based upon the size, type, and shape of bottle that the coil apparatus 100 would be paired with. The pitch 152 and trajectory 150 are chosen so as to allow the coil apparatus to be momentarily deformable in a chosen dimension, for example: height. Additionally, embodiments of the invention may further contemplate that the coil apparatus be configured so as to be momentarily deformable by temporarily changing the trajectory 150. By way of example and not limitation, an external force may be applied to the coil apparatus such that, while the force is applied, the trajectory deforms, but upon release of the external force, the coil returns to its original shape.

A preferred embodiment of the present invention, as shown in the figures generally and, particularly, in FIG. 7, discloses a trajectory 150, central axis 151, and pitch 152 that generates a coil apparatus 100 that has a substantially conical shape. The first end 110 is shown close to the base of the conical shape and the second end 120 is shown close to the top of the conical shape.

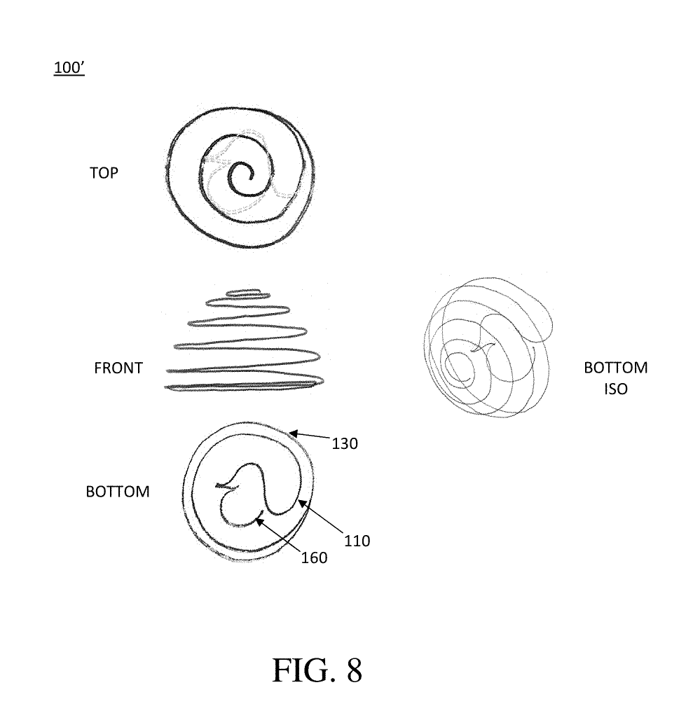

Embodiments of the coil apparatus 100′ may further comprise a figured portion 160 extending from the first end 110, as shown in FIG. 8. This figured portion 160 extends the body 130 past the first end 110 and is shaped in a different form than the rest of the coil body. Embodiments of the invention contemplate figured portions 160 that are flat, meaning substantially co planar or parallel to the cone base. Other embodiments of the invention contemplate figured portions 160 that are at an angle or orthogonal to the cone base. While figured portion 160 is illustrated in FIG. 8 in the form of a crow, it is contemplated to be a part of the present invention and disclosure that the figured portion 160 may be formed to depict any other design, logo, or figure.

Embodiments of the coil apparatus 100, 100′ may be metal or plastic, or a combination of metal and plastic. Preferred embodiments of the coil apparatus are non-toxic, food-grade materials such as food-grade stainless steel or food-grade plastic. The material for the coil apparatus 100, 100′ is to be chosen so as to be temporarily deformable, but with “memory” to return to its original shape.

Coil—Bottle System Embodiment 200

A further embodiment of the present invention includes a coil-bottle system 200 for storing, mixing, and cleaning baby formula and entertaining an infant. In this embodiment, the system is comprised of a bottle apparatus 210, a coil apparatus 100, and a seal apparatus 230.

The bottle apparatus 210 is a component having a hollow interior defined by a bottom with a perimeter and side walls extending from the base and terminating in an opening defined by the side wall edges opposite the base. In a preferred embodiment, the opening defined by the side walls is smaller than the interior of the bottle.

The coil apparatus 100 is a component as disclosed previously herein. The coil apparatus for the system embodiment is to be configured so that its larger dimension is slightly larger than the bottle apparatus 210 opening dimension but smaller than the bottle apparatus 210 interior dimension, in its default state, and smaller than the bottle apparatus 210 opening dimension in its deformed state.

The seal apparatus 230 is a component having mechanical features configured to interact with mating features in the bottle apparatus 210 such that when the seal apparatus 230 is sealably mated with the bottle apparatus 210, any contents in the bottle apparatus are substantially contained within the bottle apparatus.

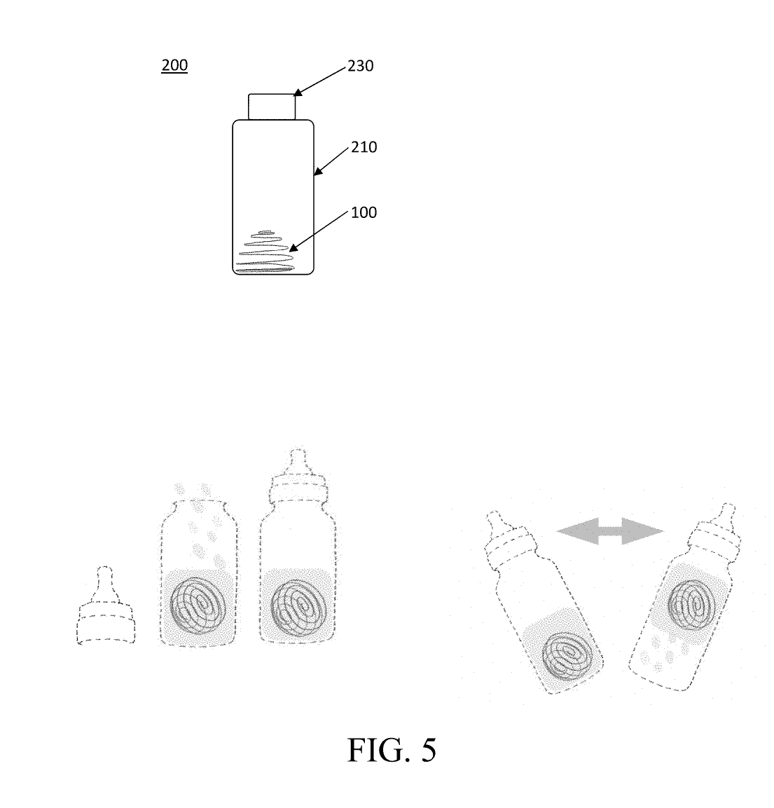

By way of example, and not limitation, a preferred embodiment of a coil-bottle system 200 is illustrated in FIG. 5 and is comprised of a one or more coil apparatus 100, a bottle apparatus 210, and a seal apparatus 230 where the bottle apparatus is a baby bottle and the seal apparatus is a baby bottle nipple with screw on ring.

The coil-bottle system embodiment described here can be used, among other uses, to store, mix, and feed baby formula, as well as to entertain the infant while using the system, and providing an easy way to clean the system after use. With this system embodiment, a parent, for example, can quickly and easily thoroughly mix powdered formula with water and feed it to their infant. The infant is entertained by the coil apparatus rattling about in the bottle. Finally, when the infant is done with the bottle, the parent can introduce fresh water into the bottle, agitate it, and the system, through the mechanical action of the coil apparatus rubbing against the bottle interior, dislodges and cleans out any powder that may have remained undissolved in the bottle.

Method Embodiment 300

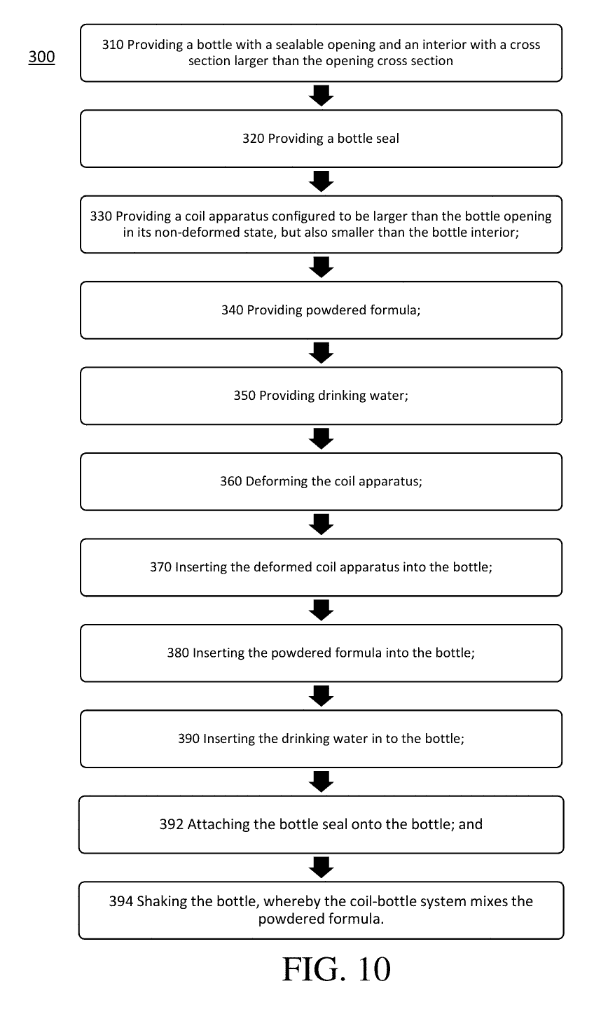

A further embodiment of the present invention discloses a method 300 related to the use of the coil apparatus 100 and the coil-bottle system 200 as illustrated in FIG. 10.

In this embodiment, the method 300 comprises the steps of:

Providing 310 a bottle with a sealable opening and an interior with a cross section larger than the opening cross section;

Providing 320 a bottle seal;

Providing 330 a coil apparatus configured to be larger than the bottle opening in its non-deformed state, but also smaller than the bottle interior;

Providing 340 powdered formula;

Providing 350 drinking water;

Deforming 360 the coil apparatus;

Inserting 370 the deformed coil apparatus into the bottle;

Inserting 380 the powdered formula into the bottle;

Inserting 390 the drinking water in to the bottle;

Attaching 392 the bottle seal onto the bottle; and

Shaking 394 the bottle, whereby the coil-bottle system mixes the powdered formula.

It is understood that the variations and options disclosed above with respect to the components of the apparatus embodiments, are also applicable as variations and options with respect to the components for the system embodiments.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims.

1. A coil apparatus for the agitation of fluids in a container, the apparatus comprising:
a first end;
a second end distal to the first end; and
a body, having a substantially consistent cross-section, disposed between and connecting the first end and the second end, wherein the body follows a pre-determined trajectory, revolving about a central axis, and at a pre-determined pitch, where the trajectory and pitch are such that the apparatus is capable of being momentarily deformable relative to the central axis.

2. The coil apparatus of claim 1, wherein the trajectory results in a substantially conically shaped apparatus having a base proximate the first end and a top proximal to the second end.

3. The coil apparatus of claim 1, further comprising a figured portion extending from the first end.

4. A coil-bottle system for the storing, mixing, and cleaning of baby formula, and further for the entertaining of an infant, the system comprising:
a bottle component having a hollow interior defined by a bottom with a perimeter and a side walls extending from the base and terminating in an opening defined by the side walls edge opposite the base, where the opening is smaller than the hollow interior of the bottle component;
a coil component having a first end, a second end distal to the first end, and a body, having a substantially consistent cross-section, disposed between and connecting the first end and the second end, wherein the body follows a pre-determined trajectory, revolving about a central axis, and at a pre-determined pitch, where the trajectory and pitch are such that the apparatus is larger than the bottle component opening in an undeformed state, but is capable of being momentarily deformable relative to the central axis, thereby momentarily becoming smaller than the bottle component opening; and
a seal component having mechanical features configured to interact with mating features in the bottle component such that the seal apparatus is sealably mated with the bottle apparatus.

5. The coil-bottle system of claim 4 where the bottle component is a baby bottle, and the seal component is a baby bottle nipple with screw on ring.

6. The coil-bottle system of claim 4, further comprising a liquid and a soluble solid.

7. The coil-bottle system of claim 4, wherein the trajectory results in a substantially conically shaped apparatus having a base proximate the first end and a top proximal to the second end.

8. The coil-bottle system of claim 4, further comprising a figured portion extending from the first end of the coil component.

9. A method related to the use of a coil apparatus and a coil bottle system, the method comprising the steps of:
Providing a bottle with a sealable opening and an interior with a cross section larger than the opening cross section;
Providing a bottle seal;
Providing a coil apparatus configured to be larger than the bottle opening in its non-deformed state, but also smaller than the bottle interior;
Providing powdered formula;
Providing drinking water;
Deforming the coil apparatus;
Inserting the deformed coil apparatus into the bottle;
Inserting the powdered formula into the bottle;
Inserting the drinking water in to the bottle;
Attaching the bottle seal onto the bottle; and
Shaking the bottle, whereby the coil bottle system mixes the powdered formula by action of the coil apparatus.
